(19) United States
(12) Patent Application Publication
(10) Pub. No.: US 2017/0186236 A1
(43) Pub. Date: Jun. 29, 2017

(54) IMAGE DISPLAY DEVICE, IMAGE DISPLAY METHOD, AND COMPUTER PROGRAM

(71) Applicant: SONY CORPORATION, TOKYO (JP)

(72) Inventor: KENTA KAWAMOTO, TOKYO (JP)

(73) Assignee: SONY CORPORATION, TOKYO (JP)

(21) Appl. No.: 15/325,308

(22) PCT Filed: Apr. 30, 2015
(86) PCT No.: PCT/JP2015/062929

§ 371 Date: Jan. 10, 2017

(30) Foreign Application Priority Data
Jul. 22, 2014 (JP) 2014-149210

(51) Int. Cl. G06T 19/00; G02B 27/01; G06F 3/01; G06F 3/00; G06F 21/32; G06F 21/36

(52) U.S. Cl. CPC G06T 19/006; G06F 21/32; G06F 21/36; G06F 3/012; G06F 3/013; G06F 3/005; G02B 27/0172; G06F 3/041

(57) ABSTRACT

There is provided an excellent image display device allowing observation of a surrounding scene by a video see-through method. While an authentication process is being performed, a head-mounted display 100 superimposes, and displays, an authentication screen on a video see-through image captured by an outside camera 312. Accordingly, a user is enabled to observe the surrounding scene by the video see-through image during the authentication process. Even when using the head-mounted display 100 while walking outdoors, the user is enabled to constantly grasp his/her surroundings, and the safety may be secured.

### CROSS REFERENCE TO RELATED APPLICATIONS

This application is a U.S. National Phase of International Patent Application No. PCT/JP2015/062929 filed on Apr. 30, 2015, which claims priority benefit of Japanese Patent Application No. JP 2014-149210 filed in the Japan Patent Office on Jul. 22, 2014. Each of the above-referenced applications is hereby incorporated herein by reference in its entirety.

### TECHNICAL FIELD

The technology disclosed in the present specification relates to an image display device used for viewing an image by being mounted on the head, for example, and an image display method and a computer program, and more particularly, to an image display device allowing observation of the surrounding scene by a video see-through method, and an image display method, and a computer program.

### BACKGROUND ART

An image display device that is mounted on the head or the face to be used for viewing an image, that is, a head-mounted display is known. The head-mounted display includes an image display unit for each of left and right eyes, for example, and may enable a user to observe a realistic image by forming an enlarged virtual image of a display image by a virtual image optical system. The head-mounted display is highly popular. If mass-produced in the future, the head-mounted display may become widespread like mobile phones, smartphones and portable game consoles, and it is conceivable that every person will own one head-mounted display.

The head-mounted display is equipped with a high-resolution display panel of liquid crystal or an organic electro-luminescence (EL) element, for example, as a display unit for left/right eye. Also, the head-mounted display may be categorized as a transmissive type or an opaque type.

A transmissive head-mounted display enables a wearer to observe the surrounding scene, while mounted on the head and displaying an image (for example, see Patent Document 1), and thus, the user may avoid dangers of running into obstacles and the like at the time of use outdoors or of use during walking.

On the other hand, an opaque head-mounted display directly covers the eyes of a wearer when mounted on the head, and the sense of immersion at the time of viewing an image is increased. By enlarging and projecting a display image by using a virtual image optical system, and enabling a user to observe an enlarged virtual image with an appropriate angle of view, and also, by reproducing multichannel sound by headphones, a realistic feeling of viewing in a movie theater may be recreated (for example, see Patent Document 2). Furthermore, also with the opaque head-mounted display, there is known a video see-through method according to which a camera for capturing the front of a wearer is built in and an external image obtained by capturing is displayed, and the wearer is enabled to observe the surrounding scene through the external image (for example, see Patent Documents 3 and 4). Additionally, in contrast to video see-through, the term “optical see-through”, or simply “see-through”, is used for the aforementioned transmissive head-mounted display.

Now, with information appliances such as multifunctional terminals, such as mobile phones, smartphones and tablets, and personal computers, whose users are limited to individuals or specific user groups, input of a passcode or a password, or an authentication process using biometric information or the like is generally performed at the time of start of use.

For example, there is proposed an electronic appliance which is provided with a touch panel display of a depression amount detection type which displays a user authentication screen for an authentication required function, checks input number information indicating a plurality of different numbers input by a user on the user authentication screen against passcode information that is stored, and releases the lock on the authentication required function in the case of match (for example, see Patent Document 5).

Also with the head-mounted display, if users are limited, such as in the case of personal use, an authentication process has to be performed at the time of start of use.

For example, there is proposed a glass-type or head-mounted image display device which allows display of an image on a display on the condition that biometric authentication, such as iris recognition, retina recognition, face morphing (morphing) or skeleton recognition, has been performed (for example, see Patent Document 6).

Furthermore, there is proposed a head-mounted display which performs user identification or an authentication process by detecting movement of the gaze position or gaze point of a user by using a myoelectric sensor or an electrooculogram sensor for detecting a muscle potential or an eye potential, and by using a movement pattern of movement of the gaze position or the gaze point of the user (for example, see Patent Document 7).

Generally, with a system which is set with an authentication function, an authentication screen is displayed at the time of start of use, and a normal operation screen is not displayed until the authentication process has been performed.

In the case of the opaque head-mounted display, both eyes of the user are covered, and the user is placed in a state of being blindfolded with no view. If a built-in camera is turned on and a captured image is in the manner of video see-through, the user regains view, and may observe the surrounding scene. However, if the authentication function is set, a video see-through image cannot be observed until the authentication process is performed, and a state of blindfold is kept. If the authentication process is disrupted by erroneous input of a password, for example, the user is placed in a dangerous state because the view becomes lost for a long time.

### SUMMARY OF THE INVENTION

### Problems to be Solved by the Invention

An object of the technology disclosed in the present specification is to provide an excellent image display device that is mounted on the head to be used for viewing of an image and that enables observation of the surrounding scene by a video see-through method, an image display method, and a computer program.

Furthermore, an object of the technology disclosed in the present specification is to provide an excellent image display device that is mounted on the head to be used for viewing of an image and that allows an authentication process to be suitably performed on a screen at the time of start of use, an image display method, and a computer program.

### Solutions to Problems

The present application was made to achieve the above object, and the technology described in claim 1 is an image display device including:
a display unit to be used by being mounted on a head or a face of a user;
a detection unit for detecting whether the display unit is mounted on the head or the face of the user;
a capturing unit for capturing surroundings; and
a control unit for controlling an image to be displayed on a screen at the display unit,
wherein the control unit causes the display unit to display a captured image of the capturing unit, in response to detection, by the detection unit, of mounting of the display unit on the head or the face of the user.

According to the technology described in claim 2 of the present application, in the image display device according to claim 1, the control unit switches the display unit from a non-display state to display of the captured image, in response to detection, by the detection unit, of mounting of the display unit on the head or the face of the user.

According to the technology described in claim 3 of the present application, the image display device according to claim 1 or 2 further includes an authentication processing unit for performing authentication of the user.

According to the technology described in claim 4 of the present application, in the image display device according to claim 3, the authentication processing unit displays an authentication screen on the captured image, in response to detection, by the detection unit, of mounting of the display unit on the head or the face of the user.

Further, the technology described in claim 5 of the present application is an image display device including:
a display unit to be used by being mounted on a head or a face of a user;
a detection unit for detecting whether the display unit is mounted on the head or the face of the user;
a capturing unit for capturing surroundings;
an authentication processing unit for performing authentication of the user; and
a control unit for controlling an image to be displayed on a screen at the display unit,
wherein the control unit displays an authentication screen on a captured image of the capturing unit during authentication processing by the authentication processing unit.

According to the technology described in claim 6 of the present application, in the image display device according to claim 4 or 5, the authentication processing unit erases the authentication screen in response to completion of authentication processing.

According to the technology described in claim 7 of the present application, the image display device according to any one of claims 1 to 6 further includes a content acquisition unit for acquiring content. Moreover, the control unit is configured to switch display on the display unit from the captured image to a content reproduction image, in response to occurrence of a predetermined event.

Further, the technology described in claim 8 of the present application is an image display method including the steps of:
detecting whether a display unit to be used by being mounted on a head or a face of a user is mounted on the head or the face of the user;
acquiring a captured image of surroundings of the user; and
causing the display unit to display the captured image, in response to detection of mounting of the display unit on the head or the face of the user.

Further, the technology described in claim 9 of the present application is an image display method including the steps of:
detecting whether a display unit to be used by being mounted on a head or a face of a user is mounted on the head or the face of the user;
acquiring a captured image of surroundings of the user; and
performing authentication of the user by displaying an authentication screen on the captured image.

Further, the technology described in claim 10 of the present application is a computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
a display unit for causing the display unit to display the captured image, in response to detection of mounting of the display unit on the head or the face of the user.

Further, the technology described in claim 11 of the present application is a computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
an authentication processing unit for performing authentication of the user by displaying an authentication screen on the captured image.

The computer programs according to claims 10 and 11 of the present application are defined as computer programs described in a computer-readable form so as to realize predetermined processing on a computer. In other words, by installing the computer program according to claim 10 or 11 of the present application in a computer, a cooperative action is exhibited on the computer, and effects similar to those of the image display method according to corresponding claim 8 or 9 of the present application may be obtained.

### Effects of the Invention

According to the technology disclosed in the present specification, there may be provided an excellent image display device that is mounted on the head to be used for viewing of an image and that allows an authentication process to be suitably performed on a screen at the time of start of use, an image display method, and a computer program.

According to the technology disclosed in the present specification, the image display device immediately displays a video see-through image after being mounted on the head or the face of a user, and thus, the user may avoid being placed in a dangerous state in which the view is blocked.

Furthermore, an image display device to which the technology disclosed in the present specification is applied is capable of superimposing, and displaying, an authentication screen on a video see-through image showing the surrounding scene captured by a built-in camera. Accordingly, the user may perform the authentication process while observing the surrounding scene by the video see-through image. The user may safely perform the authentication process while constantly checking the outside world even with a head-mounted image display device that covers the eyes of the user.

Additionally, the effects described in the present application are only examples, and the effects of the present invention are not limited thereto. Moreover, the present invention may achieve additional effects, in addition to the effects described above.

Other objects, features, and advantages of the technology disclosed in the present application will be made apparent by the detailed description based on the following embodiment and appended drawings.

### BRIEF DESCRIPTION OF DRAWINGS

FIG. 1 is a diagram showing, from the front, a user wearing a head-mounted display 100 on the head;

FIG. 2 is a diagram showing, from above, the user wearing the head-mounted display 100 shown in FIG. 1;

FIG. 3 is a diagram showing an example internal configuration of the head-mounted display 100;

FIG. 4 is a diagram showing an example of an initial screen that is displayed by the head-mounted display 100 immediately after the head-mounted display 100 is mounted on the user;

FIG. 5 is a diagram showing an example of a screen that is displayed by the head-mounted display 100 at the time of performing an authentication process for the user;

FIG. 6 is a diagram showing an example of screen transition of the head-mounted display 100; and

FIG. 7 is a diagram showing an example of screen transition of the head-mounted display 100 (for a case where an authentication function is set).

### MODE FOR CARRYING OUT THE INVENTION

Hereinafter, an embodiment of the technology disclosed in the present specification will be described in detail with reference to the drawings.

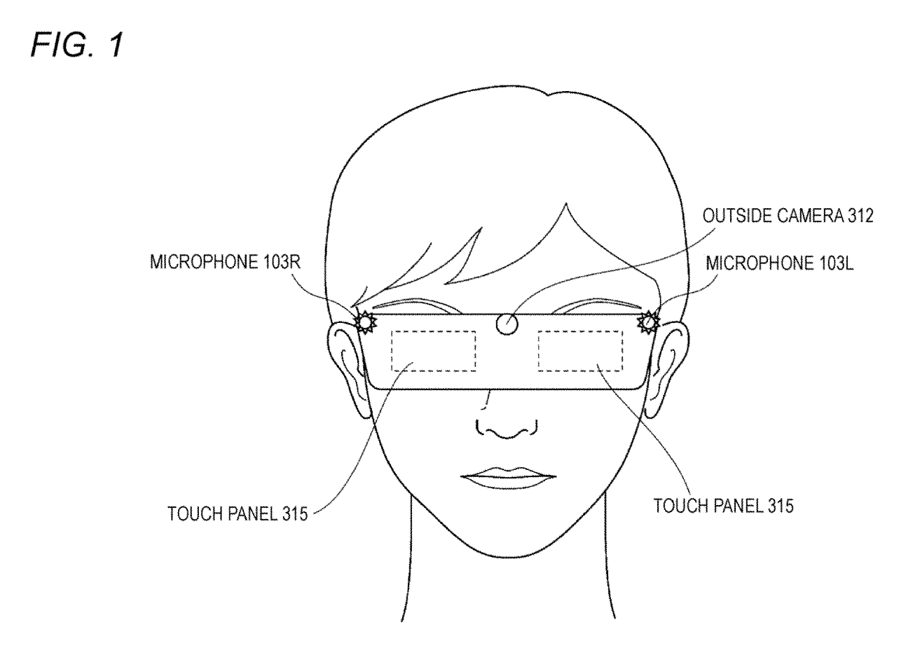

FIG. 1 is a diagram showing, from the front, a user wearing on the head a head-mounted display 100 to which the technology disclosed in the present specification is applied.

The head-mounted display 100 directly covers the eyes of a user when mounted on the head or the face of the user, and may provide the user with the sense of immersion during viewing of an image. Furthermore, unlike a see-through type, the head-mounted display 100 does not allow the user wearing the display to directly view the scene of the real world. However, by installing an outside camera 312 for capturing the scene in the direction of the gaze of the user, and by displaying the captured image, the user may indirectly view the scene of the real world (that is, the scene may be displayed in a video see-through manner). It is, of course, possible to superimpose, and show, a virtual display image, such as an augmented reality (AR) image, on the video see-through image. Moreover, because a display image cannot be seen from outside (i.e. other people) , privacy can be protected at the time of display of information.

The head-mounted display 100 shown in FIG. 1 is a structure having a shape similar to a hat, and is structured to directly cover the left and right eyes of a user wearing the display. Display panels (not shown in FIG. 1) are disposed at positions, on the inside of the main body of the head-mounted display 100, facing the left and right eyes, to be observed by the user. The display panels are configured from micro displays, such as organic EL elements or liquid crystal displays, or laser scanning displays such as retina direct drawing displays, for example.

An outside camera 312 for input of an image of the surroundings (user's view) is installed at approximately the center of the front side of the main body of the head-mounted display 100. Also, microphones 103L, 103R are installed near the left and right edges, respectively, of the main body of the head-mounted display 100. With the microphones 103L, 103R being approximately left-right symmetric, only the audio that is localized at the center (user's voice) is recognized, and can be separated from surrounding noises and voices of other people, and erroneous operation at the time of operation by audio input may be prevented, for example.

Furthermore, on the outside of the main body of the head-mounted display 100, a touch panel 315 on which the user can perform touch input using a fingertip is disposed. In the illustrated example, a pair of left and right touch panels 315 is provided, but it is also possible to provide one or three or more touch panels 315.

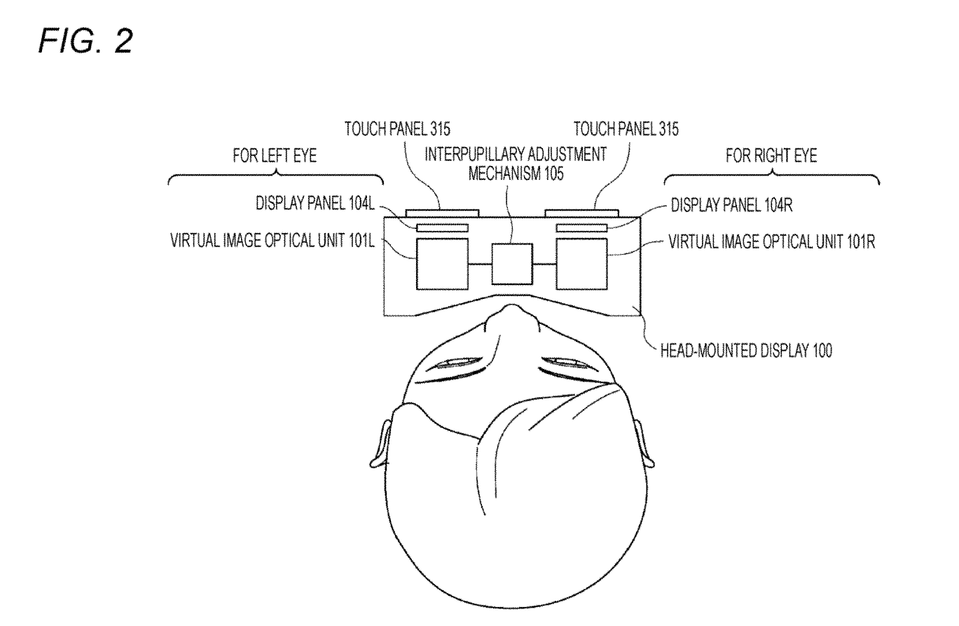

FIG. 2 is a diagram showing, from above, the user wearing the head-mounted display 100 shown in FIG. 1. The illustrated head-mounted display 100 includes display panels 104L, 104R for left and right eyes, on a side surface facing the face of the user. The display panels 104L, 104R are configured from micro displays, such as organic EL elements or liquid crystal displays, or laser scanning displays such as retina direct drawing displays, for example. A display image on the display panel 104L, 104R is transmitted through a virtual image optical unit 101L, 101R and is observed by the user as an enlarged virtual image. Moreover, because the level of the eyes or the interpupillary distance is different for each user, positions of the eyes of the user and each of left and right display systems have to be adjusted. In the example shown in FIG. 2, an interpupillary adjustment mechanism 105 is provided between the display panel for the right eye and the display panel for the left eye.

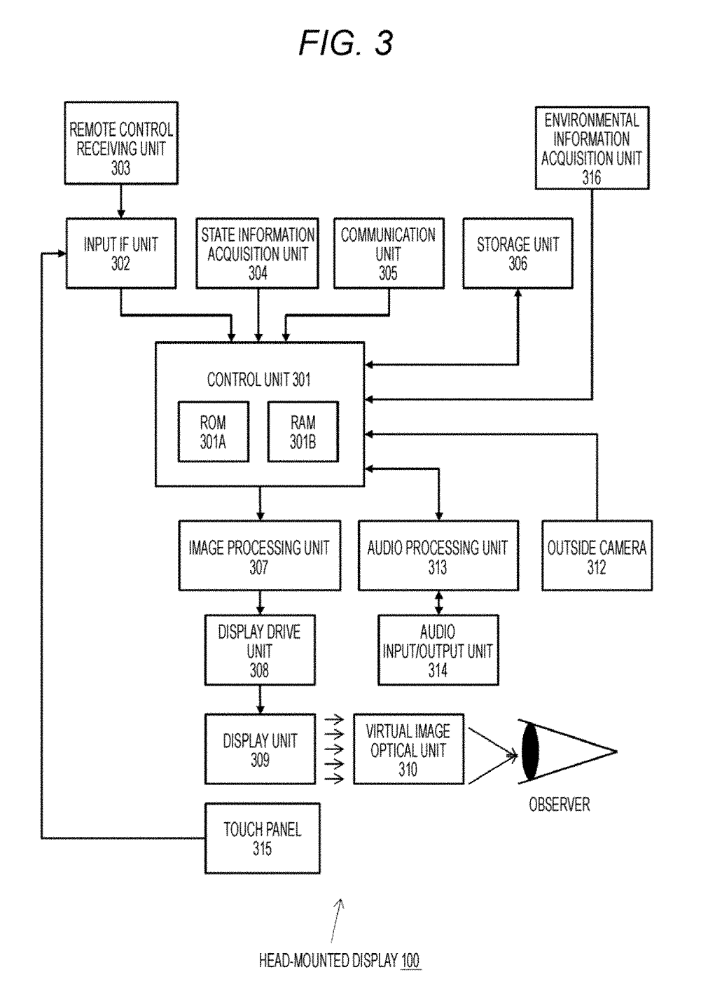

FIG. 3 is a diagram showing an example internal configuration of the head-mounted display 100. Each unit will be described in the following.

A control unit 301 includes a read only memory (ROM) 301A, and a random access memory (RAM) 301B. Program codes to be executed by the control unit 301, and various pieces of data are stored in the ROM 301A. By executing programs loaded in the RAM 301B, the control unit 301 controls the operation of the entire head-mounted display 100 in an overall manner, including control for displaying images.

Additionally, as the programs to be stored in the ROM 301A, an authentication process program to be executed at the time of start of use, and a display control program for displaying, on the screen, see-through images captured by the outside camera 312 and reproduced video images may be cited. Also, as the data to be stored in the ROM 301A, identification information unique to the head-mounted display 100, user attribute information such as authentication information (for example, a passcode, a password, or biometric information) for authenticating a user who uses the head-mounted display 100, and the like may be cited.

An input interface (IF) unit 302 includes at least one operator (not shown), such as a key, a button, or a switch, that is used by a user to perform input operation, and receives an instruction from the user through the operator, and outputs the same to the control unit 301. Also, an input operation unit 302 receives an instruction from the user in the form of a remote control command and received by a remote control receiving unit 303, and outputs the same to the control unit 301.

Furthermore, when the user performs a touch operation, with a fingertip, on the touch panel 315 disposed on the outside of the main body of the head-mounted display 100, the input interface (IF) unit 302 outputs input information such as coordinate data of the touched fingertip position to the control unit 301. For example, if the touch panel 315 is disposed on the back side of a display image (an enlarged virtual image observed through a virtual image optical unit 310) on a display unit 309, at the front of the main body of the head-mounted display 100, for example, the user may perform a touch operation as if actually touching the display image with a fingertip.

A state information acquisition unit 304 is a function module for acquiring state information of the main body of the head-mounted display 100 or the user wearing the head-mounted display 100. The state information acquisition unit 304 may be equipped with various sensors so as to detect the state information by itself, or may acquire the state information from an external appliance (for example, a smartphone or a watch worn by the user, or other multifunction terminal) provided with at least one of the sensors, via a communication unit 305 (described later).

To track the movement of the head of the user, the state information acquisition unit 304 acquires information about the position and the posture of the head of the user, or information about the posture, for example. In order to track the movement of the head of the user, the state information acquisition unit 304 is made a sensor that is capable of detecting a total of nine axes of a 3-axis gyro sensor, a 3-axis accelerometer, and a 3-axis geomagnetic sensor, for example. Furthermore, the state information acquisition unit 304 may further use, in combination, one or more sensors among a global positioning system (GPS) sensor, a Doppler sensor, an infrared sensor, a radio wave intensity sensor, and the like. Also, to acquire position/posture information, the state information acquisition unit 304 may further use, in combination, information provided by various infrastructures, such as mobile phone base station information, PlaceEngine (registered trademark) information (field measurement information from a wireless LAN access point), and the like. In the example shown in FIG. 3, the state acquisition unit 304 for tracking the movement of the head is built in the head-mounted display 100, but it may be structured as an accessory component that is externally attached to the head-mounted display 100. In the case of the latter, the state acquisition unit 304 that is externally connected expresses the posture information of the head in the form of rotation matrix, for example, and transmits the information to the main body of the head-mounted display 100 by wireless communication, such as Bluetooth (registered trademark) communication, or a high-speed wired interface, such as a universal serial bus (USB).

Furthermore, in addition to tracking of the head of the user described above, the state information acquisition unit 304 acquires, as state information of the user wearing the head-mounted display 100, for example, an operation state of the user (whether the head-mounted display 100 is mounted or not), an action state of the user (a movement state such as being still, walking or running, a gesture of hand or finger, an open/close state of eyelids, the direction of gaze, the size of pupils), a mental state (the level of emotion, the level of excitement, the level of consciousness, feelings, emotions and the like indicating whether the user is immersed or concentrating on the display image while observation), and physiological information. Furthermore, to acquire these pieces of state information from the user, the state information acquisition unit 304 may include the outside camera 312, a mounting sensor including a mechanical switch and the like, an inside camera for capturing the face of the user, various state sensors (not shown) such as a gyro sensor, an accelerometer, a speed sensor, a pressure sensor, a temperature sensor for detecting body temperature or atmospheric temperature, a sweat sensor, a pulse sensor, a muscle potential sensor, an eye potential sensor, a brain wave sensor, an expiration sensor, a gas/ion concentration sensor, a timer (not shown) and the like. Moreover, when the head-mounted display is mounted on the head of the user, the state information acquisition unit 304 may detect whether the head-mounted display 100 is mounted or not, by using a mounting sensor (for example, see Patent Document 8) for detecting that the head-mounted display 100 is worn by the user in conjunction with the motion of coming into contact with the forehead of the user.

An environmental information acquisition unit 316 is a function module for acquiring information about the surrounding environment of the main body of the head-mounted display 100 or the user wearing the head-mounted display 100. As the information about the environment here, there maybe cited sound, air volume, the atmospheric temperature, the atmospheric pressure, the environment (smoke, thick fog, electromagnetic waves (ultraviolet rays, blue light, radio waves) on the head-mounted display 100 or the user, heat rays (infrared rays), radioactive rays, carbon monoxide, carbon dioxide, oxygen, and nitrogen compounds (nicotine) in the atmosphere, nitrogen oxides (NOₓ) and hydrocarbons (volatile organic compounds: VOC) in the atmosphere or photochemical smog generated by photochemical reaction of nitrogen oxides and hydrocarbons caused by ultraviolet rays, fine particles such as particulate substances, pollen and household dust, harmful chemical substances such as asbestos), and other environmental factors. To detect the environmental information, the environmental information acquisition unit 316 may be equipped with various environment sensors typified by a sound sensor and an air flow sensor. The microphones and the outside camera 312 described above may be included as the environment sensors. Alternatively, the environmental information acquisition unit 316 may acquire the environmental information from an external appliance (for example, a smartphone or a watch worn by the user, or other multifunction terminal) provided with at least one of the sensors, via the communication unit 305 (described later).

The outside camera 312 is disposed at approximately the center of the front surface of the main body of the head-mounted display 100 (see FIG. 2), for example, and is capable of capturing an image of the surroundings. The user may adjust zooming of the outside camera 312 by operation of the input operation unit 302, or through the size of the pupils recognized by the inside camera, the muscle potential sensor or the like, or audio input. Furthermore, by performing posture control in the pan, tilt and roll directions of the outside camera 312 according to the direction of the gaze of the user acquired by the state information acquisition unit 304, an image at the eye level of the user, that is, an image in the direction of the gaze of the user, may be captured by the outside camera 312. A captured image of the outside camera 312 may be output and displayed on the display unit 309, and also, the captured image may be transmitted from the communication unit 305 or be saved in a storage unit 306.

The outside camera 312 is desirably structured from a plurality of cameras so as to be able to acquire three-dimensional information of an image of the surroundings by using parallax information. It is also possible to acquire three-dimensional information of an image of the surroundings with one camera on the basis of calculated parallax information, by using simultaneous localization and mapping (SLAM) image recognition, performing capturing while moving the camera, and calculating the parallax information by using a plurality of temporally continuous frame images (for example, see Patent Document 9).

Because it is capable of acquiring three-dimensional information, the outside camera 312 may be used also as a distance sensor. Alternatively, a distance sensor configured by an inexpensive device such as a position sensitive detector (PSD) for detecting a reflection signal from an object may be used in combination with the outside camera 312. The outside camera 312 and the distance sensor may be used to detect the position of the body, the posture, and the shape of the user wearing the head-mounted display 100.

The communication unit 305 performs a process of communicating with an external appliance (not shown), and a modulation/demodulation process and an encoding/decoding process of a communication signal. As the external appliance, there may be cited a content reproduction device (a Blu-ray disc or DVD player) that supplies a viewing content at the time of use of the head-mounted display 100 by the user, and a streaming server. Moreover, the control unit 301 transmits transmission data for the external appliance from the communication unit 305.

The configuration of the communication unit 305 is arbitrary. For example, the communication unit 305 may be configured according to the communication method that is used for transmission/reception with an external appliance which is a communication counterpart. The communication method may be wired or wireless. Communication standards in this case may be, for example, Mobile High-definition Link (MHL), Universal Serial Bus (USB), High Definition Multimedia Interface (HDMI) (registered trademark), Wi-Fi (registered trademark), Bluetooth (registered trademark) communication, Bluetooth (registered trademark) Low Energy (BLE) communication, ultra low power consumption wireless communication such as ANT, a mesh network standardized in IEEE802.11s or the like. Alternatively, the communication unit 305 may be a wireless cellular transmitter/receiver that operates according to a standard such as Wideband Code Division Multiple Access (W-CDMA) or Long Term Evolution (LTE).

The storage unit 306 is a high-capacity storage device configured as solid state drive (SSD) or the like. The storage unit 306 stores application programs to be executed by the control unit 301, and various pieces of data. For example, the user uses the head-mounted display 100 and stores content to be viewed in the storage unit 306.

An image processing unit 307 performs further signal processing such as image quality correction on an image signal that is output from the control unit 301, and also, converts the resolution according to the screen of the display unit 309. Then, a display drive unit 308 successively selects pixels of the display unit 309 on a per-row basis and performs line sequential scanning, and supplies a pixel signal based on an image signal which has been subjected to signal processing.

The display unit 309 includes a display panel that is configured from a micro display, such as an organic electro-luminescence (EL) element or a liquid crystal display, or a laser scanning display such as a retina direct drawing display, for example. The virtual image optical unit 310 enlarges and projects a display image of the display unit 309, and causes the user to observe an enlarged virtual image.

Additionally, as a display image to be output at the display unit 309, there may be cited commercial contents (virtual world) supplied by a content reproduction device (a Blu-ray disc or DVD player) or a streaming server, a captured image of the outside camera 312 (an image of the real world, such as an image of the view of the user), and the like.

An audio processing unit 313 performs audio correction or audio amplification on an audio signal that is output from the control unit 301, and signal processing on an input audio signal and the like. Moreover, an audio input/output unit 314 externally outputs audio which has been subjected to audio processing, and inputs audio from the microphones (described above).

The head-mounted display 100 according to the present embodiment is opaque, that is, it covers the eyes of the user wearing it. Moreover, commercial content such as a film, or an image expressed by computer graphics is displayed on the display unit 309. The virtual image optical unit 310 enlarges and projects the display image of the display unit 309, makes the user observe an enlarged virtual image with an appropriate angle of view, and recreates a realistic feeling of as if viewing in a movie theater, for example. The user may feel immersed in the virtual world displayed on the display unit 309.

Furthermore, the head-mounted display 100 according to the present embodiment is driven by a battery (not shown), and includes various power saving functions. For example, mounting of the head-mounted display 100 on the user is detected by the mounting sensor (described above), and an image is displayed on the display unit 309 only in the mounted state, and at other times, the display unit 309 is placed in a screen non-display state (even if the main power supply is on) so as to save power consumption.

Moreover, because the wearer is limited to a specific individual user or a specific user group, the head-mounted display 100 according to the present embodiment is equipped with the authentication function, and the authentication function is set such that an authentication process is performed at the time of start of use. The method of the authentication process is not particularly specified. For example, input of authentication information (passcode or password) using the touch panel 315, an authentication process based on the movement of the point of gaze of the user (for example, see Patent Document 7), an authentication process based on biometric information collected from the wearer, or the like may be used. However, with any of the authentication methods, an authentication screen (an input screen for authentication information, an authentication screen indicating that an authentication process is being performed) is displayed on the display unit 309 while the authentication process is being performed.

Furthermore, the timing of start of use of the head-mounted display 100 is not when the main power supply is turned on, but is when mounting of the head-mounted display 100 on the user is detected by the mounting sensor (described above). Accordingly, an authentication process is not started unless the head-mounted display 100 is mounted on the head or the face of the user even if the main power supply of the head-mounted display 100 is turned on. When mounting of the head-mounted display 100 on the user is detected, the authentication process is started, and the authentication screen is displayed.

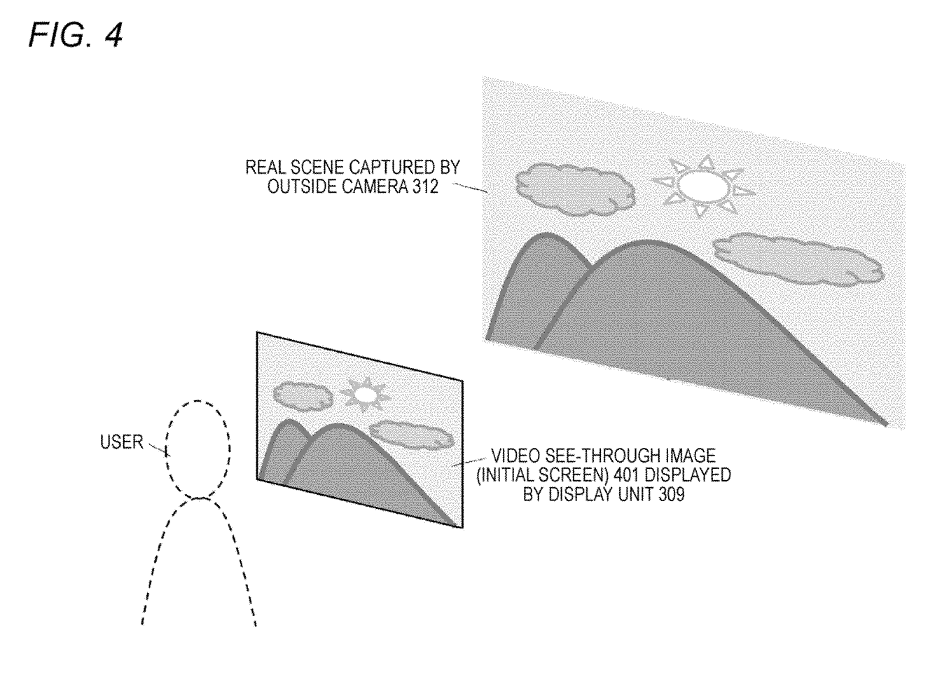

When the user wears the opaque head-mounted display 100, both eyes of the user are covered, and the user is placed in a state of being blind folded with no view. Accordingly, in the present embodiment, when mounting of the head-mounted display 100 on the head or the face of the user is detected by the mounting sensor (described above), and the use is started, a video see-through image captured by the outside camera 312 is immediately displayed on the display unit 309 as an initial screen 401 as shown in FIG. 4. Accordingly, the user may regain his/her view and observe the surrounding scene immediately after mounting of the head-mounted display 100. Then, transition may take place according to an operation of the user, for example, so as to a display screen of commercial contents (such as a film) input from outside.

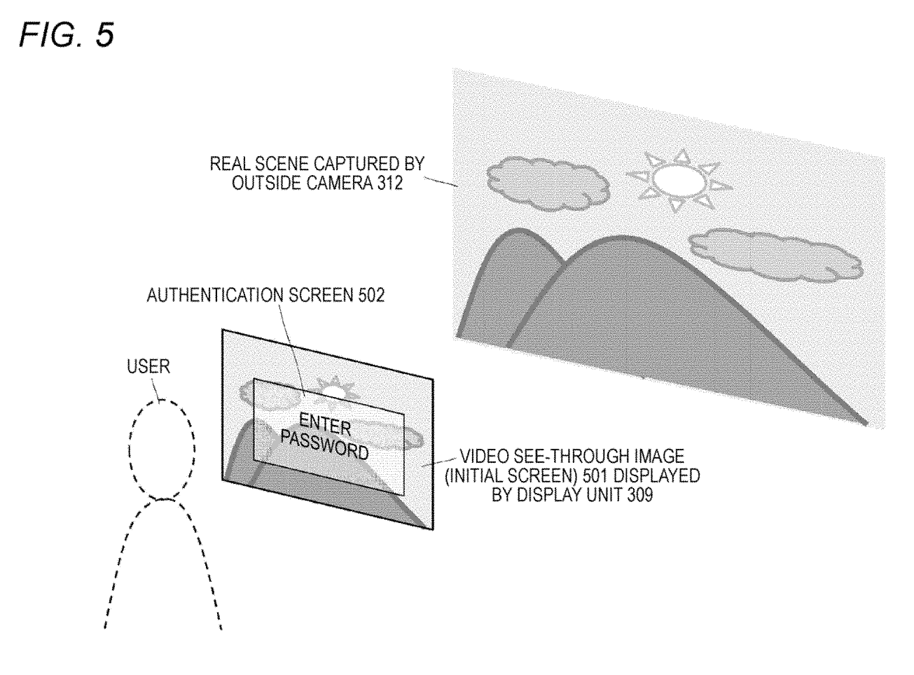

Furthermore, in the case where an authentication function is set in the head-mounted display 100, when mounting of the head-mounted display 100 on the head or the face of the user is detected by the mounting sensor (described above), and the use is started, an authentication screen is displayed on the display unit 309. If the authentication process is disrupted by an erroneous authentication operation, for example, the authentication screen is not swiftly ended. On the other hand, in the present embodiment, as shown in FIG. 5, during the authentication process, the head-mounted display 100 superimposes and displays an authentication screen 502 on a video see-through image 501 captured by the outside camera 312. Accordingly, the user is allowed to observe the surrounding scene by the video see-through image also during the authentication process. Even when using the head-mounted display 100 while walking outdoors, the user is enabled to constantly grasp his/her surroundings, and the safety may be secured. When the authentication process ends successfully, the authentication screen is erased, and only the video see-through image as the initial screen is remained. Then, transition may take place according to an operation of the user, for example, so as to a display screen of commercial contents (such as a film) input from outside.

The screen design of the authentication screen 502 is arbitrary and is according to the authentication method to be used, for example. The visibility of the surrounding scene that is displayed in a video see-through manner is increased by making the authentication screen 502 that is superimposed and displayed on the video see-through image transparent or semi-transparent.

Additionally, the outside camera 312 desirably captures an image approximately matching the gaze of the user, or to display a video see-through image obtained by converting a captured image to match the view of the user. However, the technology disclosed in the present specification is not limit to the video see-through image matching the view of the user.

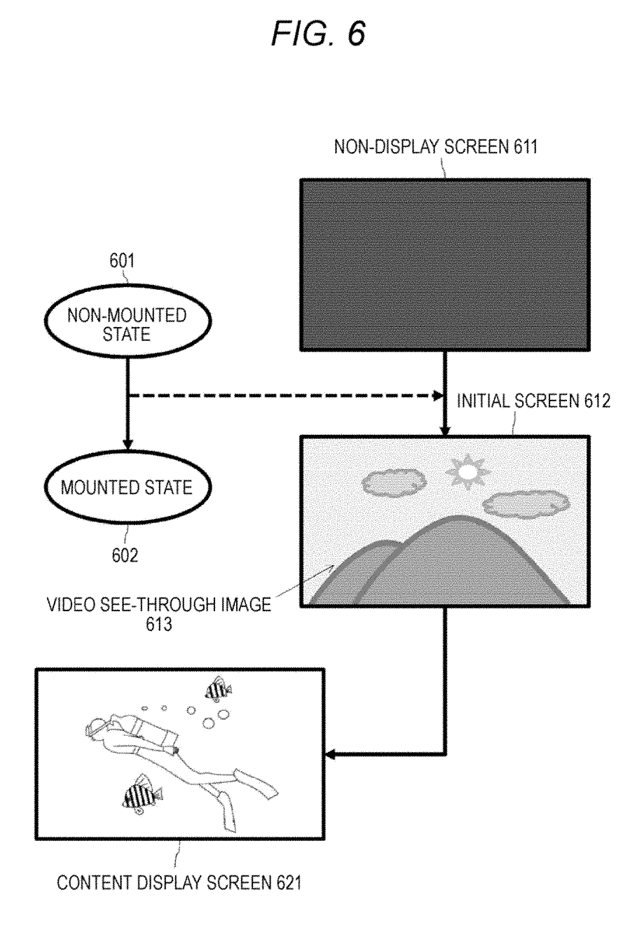

FIG. 6 shows an example of screen transition of the head-mounted display 100.

The head-mounted display 100 transitions from a non-mounted state 601 to a mounted state 602 with detection of mounting of the head-mounted display 100 on the user by the state information acquisition unit 304 provided with the mounting sensor or the like as a trigger.

In response to the state transition, the display unit 309 transitions from a non-display screen 611 to an initial screen 612. A video see-through image 613 captured by the outside camera 312 is displayed on the initial screen 612. Accordingly, the user may regain his/her view and observe the surrounding scene immediately after mounting of the head-mounted display 100. That is, the user is enabled to constantly grasp his/her surroundings, and the safety may be secured.

Then, transition to a display screen 621 for commercial contents (such as a film) to be input from outside may take place according to an operation of the user, for example, on the input operation unit 302. In this manner, when the user wears the head-mounted display 100, the video see-through image 613 is displayed, and the normal use of the head-mounted display 100 is started, and then, when dismounting of the head-mounted display 100 from the user is detected by the mounting sensor or the like, the non-mounted state 601 is reached again. Then, if mounting of the head-mounted display 100 on the user is detected again, an authentication process similar to the process described above is performed again.

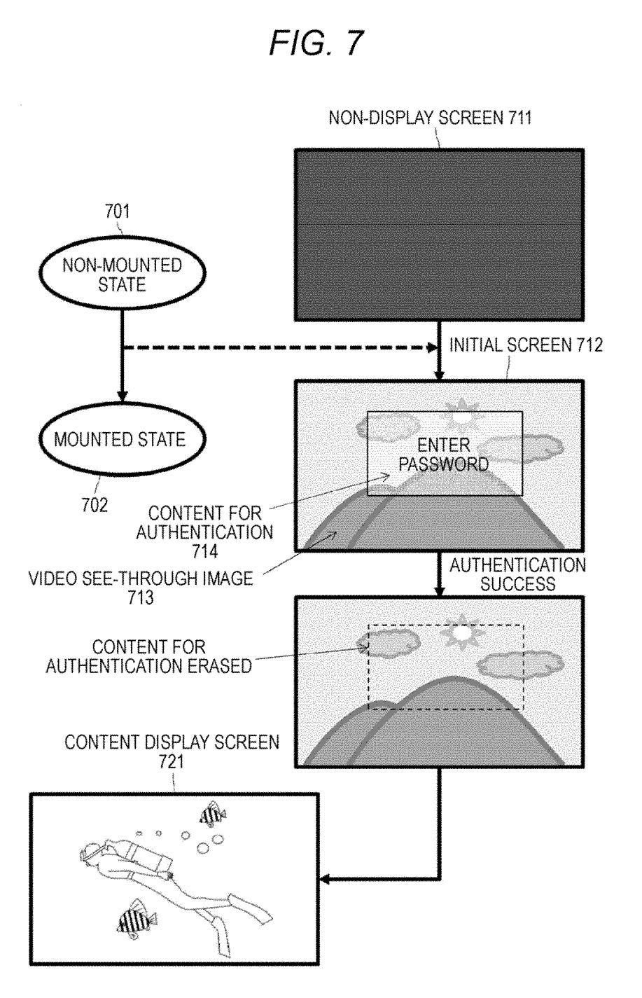

Furthermore, FIG. 7 shows an example of screen transition of the head-mounted display 100, for a case where an authentication function is set.

The head-mounted display 100 transitions from a non-mounted state 701 to a mounted state 702 with detection of mounting of the head-mounted display 100 on the user by the state information acquisition unit 304 provided with the mounting sensor or the like as a trigger.

In response to the state transition, the display unit 309 transitions from a non-display screen 711 to an initial screen 712. In the initial screen 712, content 714 for authentication processing is superimposed and displayed on a video see-through image 713 captured by the outside camera 312. The content 714 for authentication processing here is an input screen for authentication information or an authentication screen indicating that an authentication process is being performed. Accordingly, for example, even when the authentication process is started after mounting of the head-mounted display 100, the user is enabled to observe the surrounding scene through the content 714 for authentication processing. That is, the user is enabled to constantly grasp his/her surroundings, and the safety may be secured.

When the authentication process ends successfully, the content 714 for authentication processing is erased, and only the video see-through image 713 is remained.

Then, transition to a display screen 721 for commercial contents (such as a film) to be input from outside may take place according to an operation of the user, for example, on the input operation unit 302. In this manner, when the user wears the head-mounted display 100, the video see-through image 713 is immediately displayed, and when the authentication process succeeds, the normal use of the head-mounted display 100 is started, and then, when dismounting of the head-mounted display 100 from the user is detected by the mounting sensor or the like, the non-mounted state 701 is reached again. Then, if mounting of the head-mounted display 100 on the user is detected again, an authentication process similar to the process described above is performed again.

### CITATION LIST

### Patent Document

### Patent Document 1: Japanese Patent Application Laid-Open No. 2012-42654

### Patent Document 2: Japanese Patent Application Laid-Open No. 2012-141461

### Patent Document 3: Japanese Patent Application Laid-Open No. 2005-38321

### Patent Document 4: Japanese Patent Application Laid-Open No. 2011-242591

### Patent Document 5: Japanese Patent Application Laid-Open No. 2013-257661

### Patent Document 6: Japanese Patent Application Laid-Open No. 2007-3745

### Patent Document 7: Japanese Patent Application Laid-Open No. 2014-92940

### Patent Document 8: Japanese Patent Application Laid-Open No. 2012-186660

### Patent Document 9: Japanese Patent Application Laid-Open No. 2008-304268

### INDUSTRIAL APPLICABILITY

Heretofore, the technology disclosed in the present specification has been described in detail with reference to a specific embodiment. However, it is obvious that a person skilled in the art may make modifications or substitutions to the embodiment within the scope of the technology disclosed in the present specification.

In the present specification, an embodiment in which the technology disclosed in the present specification is applied to a head-mounted display of a video see-through method is mainly described, but the spirit of the technology disclosed in the present specification is not limited thereto. It is, of course, possible to apply, in the similar manner, the technology disclosed in the present specification to various types of image display devices allowing observation of the surrounding scene in a video see-through manner, other than the head-mounted display.

Furthermore, the technology disclosed in the present specification may be suitably applied to both binocular and monocular head-mounted displays.

Moreover, the technology disclosed in the present specification may be applied to various types of image display devices equipped with a camera, such as mobile phones, smartphones, tablet terminals, personal computers and the like.

In short, the technology disclosed in the present specification has been described by way of example, and the state content of the present specification should not be interpreted as being limiting. The spirit of the technology disclosed in the present specification should be determined in consideration of the claims.

Additionally, the technology disclosed in the present specification may also be configured in the following manners.

(1) An image display device including:
a display unit to be used by being mounted on a head or a face of a user;
a detection unit for detecting whether the display unit is mounted on the head or the face of the user;
a capturing unit for capturing surroundings; and
a control unit for controlling an image to be displayed on a screen at the display unit,
wherein the control unit causes the display unit to display a captured image of the capturing unit, in response to detection, by the detection unit, of mounting of the display unit on the head or the face of the user.

(2) The image display device according to (1), wherein the control unit switches the display unit from a non-display state to display of the captured image, in response to detection, by the detection unit, of mounting of the display unit on the head or the face of the user.

(3) The image display device according to (1) or (2), further including an authentication processing unit for performing authentication of the user.

(4) The image display device according to (3), wherein the authentication processing unit displays an authentication screen on the captured image, in response to detection, by the detection unit, of mounting of the display unit on the head or the face of the user.

(5) An image display device including:
a display unit to be used by being mounted on a head or a face of a user;
a detection unit for detecting whether the display unit is mounted on the head or the face of the user;
a capturing unit for capturing surroundings;
an authentication processing unit for performing authentication of the user; and
a control unit for controlling an image to be displayed on a screen at the display unit,
wherein the control unit displays an authentication screen on a captured image of the capturing unit during authentication processing by the authentication processing unit.

(6) The image display device according to (4) or (5), wherein the authentication processing unit erases the authentication screen in response to completion of authentication processing.

(7) The image display device according to anyone of (1) to (6), further including a content acquisition unit for acquiring content,
wherein the control unit switches display on the display unit from the captured image to a content reproduction image, in response to occurrence of a predetermined event.

(8) An image display method including the steps of:
detecting whether a display unit to be used by being mounted on a head or a face of a user is mounted on the head or the face of the user;
acquiring a captured image of surroundings of the user; and
causing the display unit to display the captured image, in response to detection of mounting of the display unit on the head or the face of the user.

(9) An image display method including the steps of:
detecting whether a display unit to be used by being mounted on a head or a face of a user is mounted on the head or the face of the user;
acquiring a captured image of surroundings of the user; and
performing authentication of the user by displaying an authentication screen on the captured image.

(10) A computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
a display unit for causing the display unit to display the captured image, in response to detection of mounting of the display unit on the head or the face of the user.

(11) A computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
an authentication processing unit for performing authentication of the user by displaying an authentication screen on the captured image.

### REFERENCE SIGNS LIST

100 Head-mounted display
101L, 101R Virtual image optical unit
103L, 103R Microphone
104L, 104R Display panel
105 Interpupillary adjustment mechanism
301 Control unit
301A ROM
301B RAM
302 Input operation unit
303 Remote control receiving unit
304 State information acquisition unit
305 Communication unit
306 Storage unit
307 Image processing unit
308 Display drive unit
309 Display unit
310 Virtual image optical unit
312 Outside camera
313 Audio processing unit
314 Audio input/output unit
315 Touch panel
316 Environmental information acquisition unit

1. An image display device comprising:
a display unit to be used by being mounted on a head or a face of a user;
a detection unit for detecting whether the display unit is mounted on the head or the face of the user;
a capturing unit for capturing surroundings; and
a control unit for controlling an image to be displayed on a screen at the display unit,
wherein the control unit causes the display unit to display a captured image of the capturing unit, in response to detection, by the detection unit, of mounting of the display unit on the head or the face of the user.

2. The image display device according to claim 1, wherein the control unit switches the display unit from a non-display state to display of the captured image, in response to detection, by the detection unit, of mounting of the display unit on the head or the face of the user.

3. The image display device according to claim 1, further comprising an authentication processing unit for performing authentication of the user.

4. The image display device according to claim 3, wherein the authentication processing unit displays an authentication screen on the captured image, in response to detection, by the detection unit, of mounting of the display unit on the head or the face of the user.

5. An image display device comprising:
a display unit to be used by being mounted on a head or a face of a user;
a detection unit for detecting whether the display unit is mounted on the head or the face of the user;
a capturing unit for capturing surroundings;
an authentication processing unit for performing authentication of the user; and
a control unit for controlling an image to be displayed on a screen at the display unit,
wherein the control unit displays an authentication screen on a captured image of the capturing unit during authentication processing by the authentication processing unit.

6. The image display device according to claim 5, wherein the authentication processing unit erases the authentication screen in response to completion of authentication processing.

7. The image display device according to claim 1, further comprising a content acquisition unit for acquiring content,
wherein the control unit switches display on the display unit from the captured image to a content reproduction image, in response to occurrence of a predetermined event.

8. An image display method comprising the steps of:
detecting whether a display unit to be used by being mounted on a head or a face of a user is mounted on the head or the face of the user;
acquiring a captured image of surroundings of the user; and
causing the display unit to display the captured image, in response to detection of mounting of the display unit on the head or the face of the user.

9. An image display method comprising the steps of:
detecting whether a display unit to be used by being mounted on a head or a face of a user is mounted on the head or the face of the user;
acquiring a captured image of surroundings of the user; and
performing authentication of the user by displaying an authentication screen on the captured image.

10. A computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
a display unit for causing the display unit to display the captured image, in response to detection of mounting of the display unit on the head or the face of the user.

11. A computer program described in a computer-readable form, the computer program being for causing a computer to function as:
a detection unit for detecting whether a display unit to be used by being mounted on a head or a face of a user is mounted on the head or the face of the user;
an image acquisition unit for acquiring a captured image of surroundings of the user; and
an authentication processing unit for performing authentication of the user by displaying an authentication screen on the captured image.
